(19) United States
(12) Patent Application Publication
(10) Pub. No.: US 2010/0149029 A1
(43) Pub. Date: Jun. 17, 2010

(54) System and Method for Obtaining Location Assistance Data

(75) Inventors: William O. Camp, JR., Chapel Hill, NC (US); Phillip Marc Johnson, Durham, NC (US)

Correspondence Address: COATS & BENNETT/SONY ERICSSON, 1400 CRESCENT GREEN, SUITE 300, CARY, NC, 27518, US

(73) Assignee: SONY ERICSSON MOBILE COMMUNICATIONS AB, Lund (SE)

(21) Appl. No.: 12/334,756

(22) Filed: Dec. 15, 2008

(51) Int. Cl. G01S 5/14

(52) U.S. Cl. 342/357.08

(57) ABSTRACT

An electronic device such as a cellular telephone, for example, includes a receiver that receives broadcast radio signals transmitted by a commercial broadcast radio station. The broadcast radio signals include information that identifies a location of the radio station, an antenna associated with the radio station, or the radio station. The device also includes positioning circuitry to allow the device to determine its current location. A controller in the device extracts the information identifying the radio station from the received broadcast signal, and acquires one or more satellites of a navigational system based on the information.

### BACKGROUND

The present invention relates generally to consumer electronic devices equipped with broadcast radio receivers, and particularly to those electronic devices that are capable of determining a geographical position.

The Global Positioning System (GPS) is a global navigational system comprising a constellation of satellites that orbit the Earth. These satellites transmit precise signals that allow GPS receivers on the Earth's surface to determine their current geographical locations, time, and velocity. The GPS system is perhaps one of the most widely used for navigation; however, other satellite navigation systems include the Russian Global Orbiting Navigation Satellite System (GLONASS) and the European Union's proposed Galileo positioning system.

Generally, a GPS receiver must initially acquire the transmitted RF signals corresponding to multiple GPS satellites in orbit around the Earth before it can calculate its geographical position. To aid in the initial acquisition of the GPS satellites, the GPS receivers on the Earth's surface may use assistance data. GPS assistance data is provided to a GPS receiver and comprises three core elements—a reference location, a reference time, and ephemeris data for the viewable satellites. The reference location is a fixed location on the surface of the Earth, usually within reasonably close proximity of the GPS receiver. The reference time is an initial time value provided to the GPS receiver. The ephemeris data comprises orbital and clock correction data. Using well-known techniques, the GPS receiver uses the reference location, reference time, and the ephemeris data to quickly acquire the RF signals from the visible GPS satellites, and determine the positions of those satellites. The use of GPS assistance data serves to reduce the Time-to-First-Fix (TTFF) since the GPS receiver can limit its search to only the visible satellites, and further limit the range of time and Doppler frequencies over which the receiver must search for each satellite. Once the satellite positions are known, the GPS receiver can calculate its geographical coordinates on the surface of the Earth.

There are many known methods by which the GPS assistance data is provided to GPS receivers. One method, for example, is the Assisted GPS (A-GPS) method. A-GPS systems employ a cellular radio network to provide GPS equipped devices, such as cellular telephones having an integrated GPS receiver, with the GPS assistance data. However, not all cellular network carriers provide assistance data. Of those that do, many provide assistance data for emergency services only.

### SUMMARY

The present invention provides an electronic device that determines navigational assistance data based on identifying information provided by commercial broadcast radio stations. This allows the device to quickly acquire one or more satellites in a navigational system.

In one embodiment, the device comprises a broadcast radio receiver capable of receiving broadcast radio signals. By way of example, the radio signals may be transmitted by an FM broadcast radio station and carry multimedia content, such as music, and informational content associated with the music. The informational content may comprise a Radio Systems Data (RDS) stream that identifies the name of a song being played and/or the artist performing the song, and may be displayed for the user. The RDS stream may also include identifying information that assists the device in acquiring one or more navigational satellites. For example, in one embodiment, the identifying information may include geographical coordinates that identifies the location of a broadcast radio station, or an antenna tower associated with the broadcast radio station. The device can use these coordinates as a reference location to acquire the satellites. In another embodiment, the identifying information identifies the broadcast radio station transmitting the radio signals. In the absence of the explicit geographical coordinates, the device can use the broadcast radio station identity to determine a reference location.

In one embodiment, for example, the device comprises positioning circuitry to allow the device to determine its geographical position on the surface of the Earth using a navigational system such as the Global Positioning System (GPS). A controller in the device determines the identity of a broadcast radio station from the informational content of a received radio signal. The identity may be the call sign or call letters of the broadcast radio station. The controller generates a request message including the call letters, and sends the message to a network server maintained, for example, by an agency such as the Federal Communications Commission (FCC).

Upon receipt, the network server uses the call sign in the request message to determine the geographical coordinates of a fixed-site antenna tower that belongs to the broadcast radio station and returns that information to the requesting device. The electronic device can then use those coordinates as a reference location, as well as other assistance data, to acquire the satellites.

### BRIEF DESCRIPTION OF THE DRAWINGS

FIG. 1 is a diagram illustrating an exemplary operating environment for a consumer electronic device configured according to one embodiment of the present invention.

FIG. 2 is a block diagram illustrating some of the components of an electronics device configured according to one embodiment of the present invention.

FIG. 3 illustrates a portion of a Radio Data System (RDS) message received by an electronics device configured to operate according to one embodiment of the present invention.

FIG. 4 is a flow diagram illustrating a method of determining a reference location according to one embodiment of the present invention.

FIG. 5 is a flow diagram illustrating another method of determining a reference location according to one embodiment of the present invention.

FIG. 6 is a flow diagram illustrating another method of determining a reference location according to one embodiment of the present invention.

FIG. 7A is a perspective view illustrating the position of a reference location determined according to one embodiment of the present invention relative to the geographical locations of broadcast radio station antennas.

FIG. 7B is a perspective view illustrating the position of a reference location determined according to another embodiment of the present invention relative to the geographical locations of broadcast radio station antennas.

### DETAILED DESCRIPTION

The present invention provides an electronic device equipped with both a Frequency Modulated (FM) receiver and a Global Positioning System (GPS) receiver with GPS assistance data using information obtained via a commercial radio broadcast network. The device, which may be a GPS equipped cellular telephone, for example, receives an FM signal broadcast by a broadcast radio station. The FM signal has a multimedia component carrying multimedia content, such as a song, for example, and a separate information component referred to as a Radio Data System (RDS) signal. The RDS signal usually carries information regarding the multimedia content being received, such as the title of the song and the name of the artist performing the song. However, in some cases, the RDS signal may also include identifying information that can be employed to acquire one or more satellites in orbit around the Earth.

In one embodiment, the identifying information carried by the RDS signal indicates the geographical coordinates of the broadcast radio station, or of an antenna tower associated with the broadcast radio station, for example. Upon receipt, the device uses the coordinates as a reference location and, along with other GPS assistance data, acquires one or more satellites in orbit around the Earth.

In cases where the RDS signal does not carry such explicit coordinates, the device may determine a reference location from information carried by the RDS signal that identifies the broadcast radio station responsible for transmitting the multimedia content. Such identifying information includes, but is not limited to, the call sign of the broadcast radio station broadcasting the multimedia content, or some other identifying information. Based on this identifying information, the electronic device determines the location of the radio station antenna tower, and uses the tower location as a reference location, along with other assistance data, to acquire the plurality of satellites it will need to determine its geographical location. Such other assistance data, for example, a reference time and ephemeris data, may also be carried by the RDS signal.

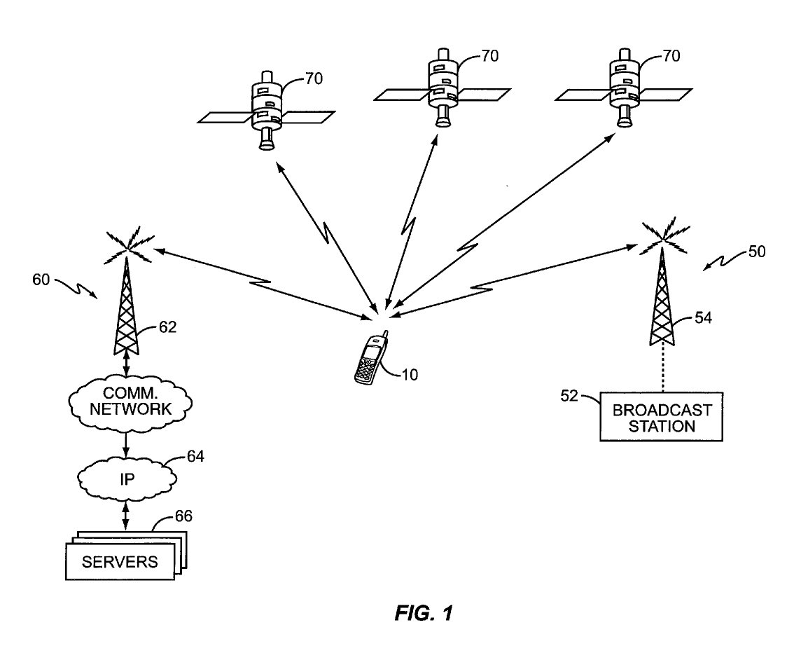

FIG. 1 illustrates a system in which an electronic device 10 configured according to one embodiment of the present invention may operate. For illustrative purposes only, the electronic device 10 of FIG. 1 is a cellular telephone. However, those skilled in the art will readily appreciate that the present invention is applicable to any consumer electronics device capable of receiving broadcast signals and determining its position using GPS. Thus, as used herein, wireless communications devices is intended to include other devices such as Personal Digital Assistants (PDAs), Personal Communication Services (PCS) devices, palm computers, stand-alone navigational devices, and the like.

Wireless communications device 10 receives broadcast radio signals from a commercial broadcast radio network 50. Network 50 provides users with commercial radio programming and typically includes a broadcast radio station 52 coupled to an antenna 54 located at a fixed position. Broadcast radio station 52 may be any publicly or privately owned broadcast radio station such as an FM radio station. The radio signals broadcast by the radio station 52 are typically modulated RF carrier signals that carry multimedia content, such as music. However, in accordance with the present invention, the radio station 52 also includes equipment necessary to transmit a data signal such as RDS. Suitably equipped receivers receive and decode the information carried by the RDS signal for display to the user.

In one embodiment, the device 10 includes a receiver that operates in the FM radio band (between 87.5 MHz and 108 MHz in the US). However, it should be understood that the use of the FM radio band to effect the present invention as discussed throughout the embodiments is for illustrative purposes only. The present invention is not limited solely to receiving such information from an FM radio station, but rather, may receive a data signal over other radio bands and frequencies that are appropriate for other regions.

Device 10 communicates with remote parties via a wireless communications network 60 that includes a Base Station (BS) 62 coupled to an antenna, which may be a fixed-site antenna tower, for example. Network 60 may operate according to any known standard, including Global System for Mobile Communications (GSM), TIA/EIA-136, cdmaOne, cdma2000, UMTS, and Wideband CDMA. As is known in the art, network 60 provides a connection to external packet data networks 64 such as the Internet.

Network 60 also provides access to one or more third-party servers 66 via the packet data network 64. In one embodiment, the server(s) 66 can access a database of geographical coordinates identifying the precise geographical locations of one or more commercial broadcasting radio station antenna towers 54. As described in more detail later, device 10 may query the server(s) 66 to obtain these locations based on information extracted from an RDS signal received at the device 10. The device 10 can then use those coordinates as a reference location to aid in acquiring one or more GPS satellites in orbit around the Earth.

A navigational satellite network comprises a plurality of satellites 70 in orbit around the Earth. As previously stated, device 10 receives navigational signals from satellites 70 that are visible to the device 10, and uses those signals to compute its geographic location on the surface of the Earth. However, initially acquiring the satellites 70 to obtain a fix on a position can be time consuming, especially for those devices 10 that have been turned off for an extended period of time, or that have moved a large distance since last calculating a position. As will be described later in more detail, the device 10 can extract information from an independently broadcast radio signal, and use that extracted information to determine a reference location that will assist the device 10 in quickly acquiring the satellites 70.

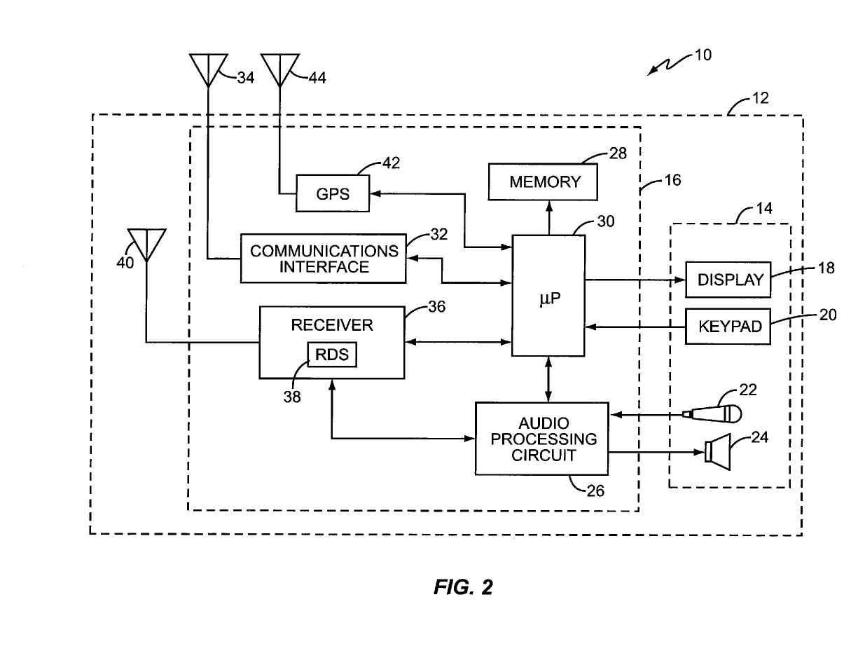

FIG. 2 illustrates a wireless communications device 10 configured according to one embodiment of the present invention. As seen in FIG. 2, wireless communications device 10 comprises a housing 12, a user interface 14, and communications circuitry 16. User interface 14 provides a user with the necessary elements to interact with wireless communications device 10, and includes a display 18, a keypad 20, a microphone 22, and a speaker 24. Display 18 displays information extracted from the RDS signal after decoding by the wireless communication device 10. This information identifies multimedia content being transmitted by the commercial broadcast radio station 52, and may include information such as the title of a song and the artist performing the song currently being broadcast by the radio station. In at least one embodiment, the information also comprises data that identifies the broadcast radio station 52 transmitting the multimedia content.

Keypad 20 may be disposed on a face of wireless communications device 10, and includes an alphanumeric keypad and other input controls such as a joystick, button controls, or dials. Keypad 20 allows the operator to dial numbers, enter commands, and select options from menu systems, as well as permit the user to enter frequency information to tune to a selected broadcast station. Microphone 22 converts the user's speech into electrical audio signals, and speaker 24 converts audio signals into audible sounds that can be heard by the user.

Communications circuitry 16 comprises a controller 30, memory 28, an audio processing circuit 26, a communications interface 32 connected to an antenna 34, a receiver 36 having an antenna 40, and a GPS receiver 42 connected to an antenna 44. Memory 28 represents the entire hierarchy of memory in wireless communications device 10, and may include both random access memory (RAM) and read-only memory (ROM). Computer program instructions and data required for operation of wireless communications device 10 are stored in non-volatile memory, such as EPROM, EEPROM, and/or flash memory, and may be implemented as discrete devices, stacked devices, or integrated with controller 30.

Controller 30 controls the operation of wireless communications device 10 according to programs stored in memory 28. The control functions may be implemented, for example, in a single microprocessor, or in multiple microprocessors. Suitable microprocessors may include general purpose and special purpose microprocessors, as well as digital signal processors. Controller 30 may interface with audio processing circuit 26, which provides basic analog output signals to speaker 24 and receives analog audio inputs from microphone 22. As described in more detail below, controller 30 can generate and/or obtain GPS assistance data based on information extracted from the RDS signal received from broadcast radio station 52.

Wireless communications device 10 also comprises a communications interface 32. In FIG. 2, the communications interface 32 comprises a long-range transceiver coupled to antenna 34 for transmitting and receiving signals to and from one or more base stations 62 in network 60. The transceiver may comprise a fully functional cellular radio transceiver that operates according to any known standard, including Global System for Mobile Communications (GSM), TIA/EIA-136, cdmaOne, cdma2000, UMTS, and Wideband CDMA. The transceiver preferably includes baseband-processing circuits to process signals transmitted and received by the transceiver. Alternatively, the baseband-processing circuits may be incorporated in the controller 30.

GPS receiver 42 is coupled to antenna 44, and receives signals transmitted from the GPS satellites 70. The GPS receiver 42 typically includes an RF component as well as the baseband correlation circuitry required for detecting GPS signals. The method by which the GPS receiver 42 uses the signals received from the satellites 70 to calculate a current geographical position of device 10 is well-known in the art. Therefore, these processes are not described in detail here. It is sufficient to understand that GPS receiver 42 is coupled to controller 30. The controller 30 controls the positioning capabilities as desired by the user, and can provide GPS assistance data to the GPS receiver 42. The controller may also transfer data acquired or derived from the communications interface 32 or the broadcast receiver 36 to the GPS receiver 42.

Broadcast receiver 36 is coupled to antenna 40, and receives and demodulates signals broadcast by a radio station, such as an AM or FM radio station, for output to the user over speaker 24. Broadcast receiver 36 is suitable for use with RDS systems, and thus, may be equipped with an RDS module 38 to decode the RDS signals transmitted by the broadcast radio station 52. To receive the multimedia content, receiver 36 must be tuned to the particular transmit frequency assigned to the broadcast radio station of interest. As is known in the art, receivers may use a resonance circuit to separate a radio signal of interest from the thousands of radio signals that permeate the environment. For example, receiver 36 may be tuned to a radio frequency of an FM radio station, such as 96.1 MHz, or of an AM radio station, such as 680 KHz. In these cases, receiver 36 will be tuned such that it selects only those radio signals being transmitted at 96.1 MHz or 680 KHz, respectively.

RDS module 38 decodes received RDS signals contained within the broadcast radio signals. Such circuitry is well-known in the art, and thus, only a brief overview of the circuitry is contained herein. However, for more information on the circuitry, messaging, encoding/decoding, or on RDS in general, the interested reader is directed to the international RDS standards document IEC 62106 entitled “Specification of the Radio Data System (RDS) for VHF/FM sound broadcasting in the frequency range from 87.5 to 108.0 MHz,” December 1999. That document is published by the International Electrotechnical Commission (IEC) and is incorporated herein by reference in its entirety.

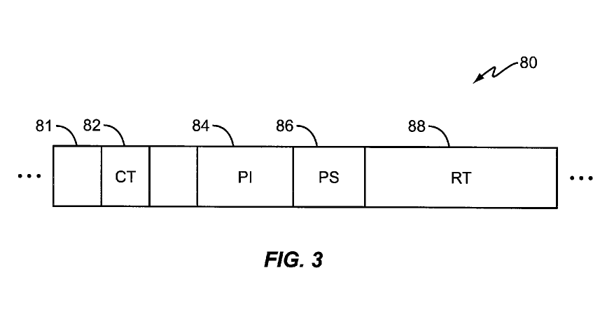

The signal received from FM broadcast radio station 52 is sent to the audio processing circuit 26 for rendering as audible sound over speaker 24. The received signal is also sent to RDS module 38 for processing. RDS module 38 decodes a 57 kHz subcarrier signal specified by the RDS standards, and extracts any information carried thereon. The RDS information carried by the subcarrier signal has a well-known message format that is detailed in the RDS IEC 62106 standards document. For clarity, however, FIG. 3 illustrates a portion of an RDS message 80 decoded by the RDS module 38.

RDS message 80 has a plurality of fields. Typically, the RDS text that identifies the title of a song and the artist performing the song is carried in the Radio Text (RT) field 88. However, the RDS message 80 may contain other information as well. Once decoded, this information may be sent to the display 18 for display to the user, and to the controller 30 for use as assistance data according the present invention.

For example, in one embodiment, the RDS message 80 may carry an indicator field 81 to indicate whether the RDS message 80 is one that carries data helpful for determining assistance data. The indicator field 81 may, for example, be a flag. The Clock Time (CT) field 82 carries date and time information. In some embodiments of the present invention, the controller 30 can use this time as an initial “reference time” when acquiring the GPS satellites. In other embodiments, the controller 30 periodically synchronizes a local clock to the time information carried in the CT field 82, and then uses the local clock for the reference time.

The PI field 84 carries a code that uniquely identifies the broadcast radio station 52 transmitting the RDS signal with the multimedia content. Generally, the PI code comprises a country prefix followed by a specific code, which in the United States, is determined by applying a predetermined formula to the station's call sign (e.g., WABC, WMMR, WYSP). The PS field 86 carries data representing the broadcast radio station's 52 call letters or identity name. In one embodiment of the present invention, the information carried by the PI field 84 and/or the PS field 86 may be displayed to the user, and sent to the controller 30 for use in determining a reference location.

As previously stated, GPS equipped devices sometimes have difficulty initially acquiring GPS satellites. This may occur, for example, in areas of poor signal reception, or when the reference location, time, and/or ephemeris data is stale. Further, not all networks provide the GPS equipped devices with GPS assistance data. Therefore, according to the present invention, the GPS equipped devices use data received with the RDS message 80 as GPS assistance data to aid in the initial acquisition of the GPS satellites. In one embodiment, the GPS message 80 includes geographical coordinates identifying, for example, the location of the broadcast radio station 52 or of the antenna 54 transmitting the radio signal. Upon receipt, controller 30 could use these coordinates as a reference location when acquiring one or more of the GPS satellites 70. However, not all broadcast radio stations 52 will provide such coordinates. Therefore, in another embodiment, the present invention determines a reference location from other identifying information provided in the RDS message 80.

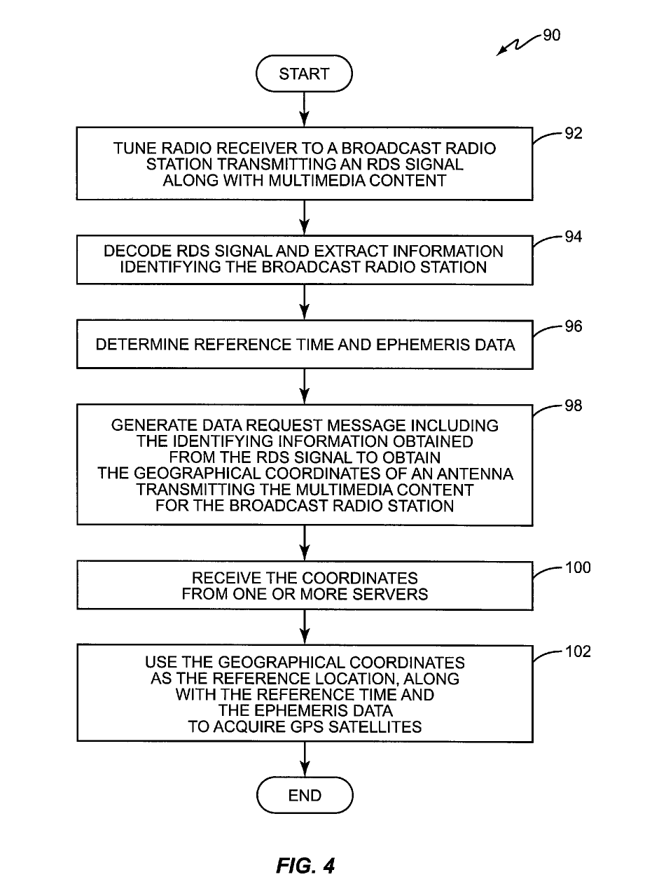

FIG. 4 is a flow diagram illustrating one method 90 for obtaining GPS assistance data according to one embodiment of the present invention. In method 90, a user of device 10 tunes the broadcast receiver 36 to the frequency of a broadcast radio station 52 transmitting an RDS signal along with multimedia content (box 92). Upon receiving and decoding the RDS signal, the controller 30 may parse the RDS message 80 to extract the call sign information from either the PI field 84 or the PS field 86 (box 94). The controller 30 may also obtain a reference time from the CT field 82, as well as ephemeris data if it is provided (box 96). The controller 30 then generates a data request message including the call sign information, and sends it to the network server(s) 66 to request the geographical location of the antenna 54 associated with the broadcast radio station 52 transmitting the received content (box 98). The servers may be, for example, publicly accessible servers maintained by a regulatory body such as the Federal Communications Commission (FCC). In one embodiment, the server(s) 66 use the call letters as an index into a database to retrieve the corresponding geographical coordinates of the antenna 54 transmitting the multimedia content. The server(s) 66 returns those coordinates to device 10 (box 100). Upon receipt, the controller 30 uses these received coordinates as the reference location, as well as the reference time and ephemeris data, to acquire the GPS satellites (box 102).

Simply tuning the receiver 36 to a broadcast radio station 52 is not the only method by which the present invention can obtain a reference location. In another embodiment, the controller 30 is programmed to intelligently decide which broadcast radio station 52 from a plurality of broadcast radio stations received at device 10 to use in determining a reference location. For example, a reference location that is within about 300 km of the device's 10 actual location will permit the device 10 to acquire the GPS satellites and determine its location quickly. Therefore, it is preferable that the device 10 use the location of a fixed antenna 54 that is near the device 10 as a reference location.

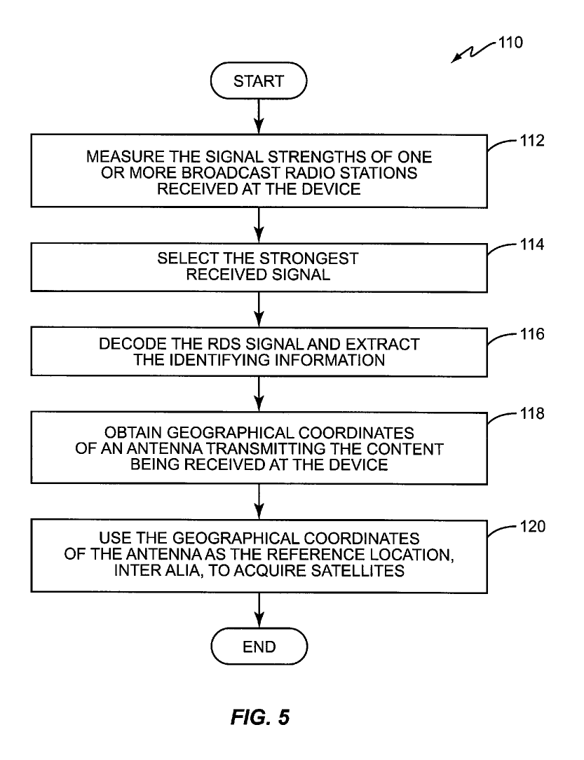

FIG. 5 illustrates one method 110 in which controller 30 assumes that device 10 is nearest the antenna 54 having the strongest received signal strength. As seen in FIG. 5, controller 30 measures the received signal strengths of a plurality of broadcast radio stations 52 (box 112), and selects the broadcast radio station 52 having the strongest received signal strength (box 114). Controller 30 assumes that the device 10 is nearest the antenna 54 corresponding to the strongest received signal, and decodes the RDS message 80 transmitted by that broadcast radio station 52. Particularly, the controller 30 extracts the information from the PI or PS fields 84, 86 (box 116) and generates a request message including the extracted information. The controller 30 then sends the request message to the network server(s) 66 to determine the antenna coordinates as previously described (box 118), and uses the coordinates as a reference location to acquire the satellites (box 120).

The receiver 36 in device 10 may be configured to automatically tune to the frequencies of different broadcast radio stations 52 without requiring user input. Further, the controller 30 may perform the tuning procedures as a background process. Once tuned to a frequency, the controller 30 could be configured to extract the information identifying the radio station from the PI field 84 or the PS field 86. Additionally, if provided, the controller 30 may be configured to automatically extract the time data from the CT field 82 and/or the ephemeris data from the RDS message 80.

Some broadcast radio stations 52 may not send an RDS signal having information that is useful in obtaining GPS assistance data. Therefore, in one embodiment of the present invention, the GPS indicator field 81 may comprise a flag or other value that indicates whether the RDS message 80 does or does not include data that controller 30 may use to obtain GPS assistance data. By way of example, when the controller 30 tunes receiver 36 to a given frequency for a broadcast radio station 52, the controller 30 could search for the presence of an indicator in the GPS indicator field 81. If the indicator value indicates that the RDS message 80 includes helpful data, the controller 30 would know to extract the identifier information from the PI field 84 or the PS field 86. If the indicator value indicates otherwise (i.e., that the GPS message 80 does not contain helpful data), the controller 30 could save resources by not decoding and/or extracting the data from the RDS message 80.

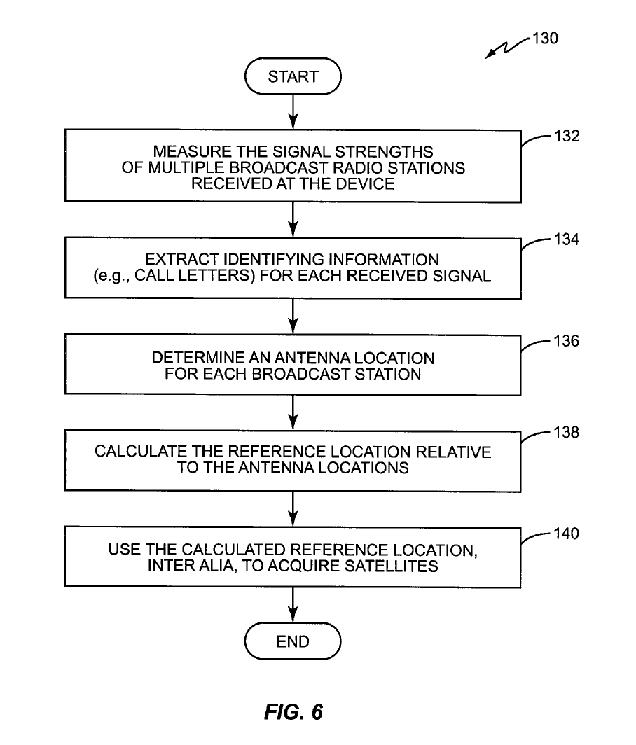

FIG. 6 illustrates another method 130 by which controller 30 may determine a reference location for use as GPS assistance data. Method 130 begins by device 10 measuring the received signal strengths from a plurality of broadcast radio stations 52 (box 132). For each received signal, the RDS module 38 decodes a corresponding RDS message 80, and controller 30 extracts the call letters from the PI or PS fields 84, 86 to identify the transmitting broadcast radio station 52 (box 134). The controller 30 then determines an antenna location for each selected broadcast radio station (box 136), and calculates the reference location relative to the antenna locations (box 138). As in the previous embodiments, the calculated reference location is then used by controller 30 as the reference location to acquire the GPS satellites (box 140).

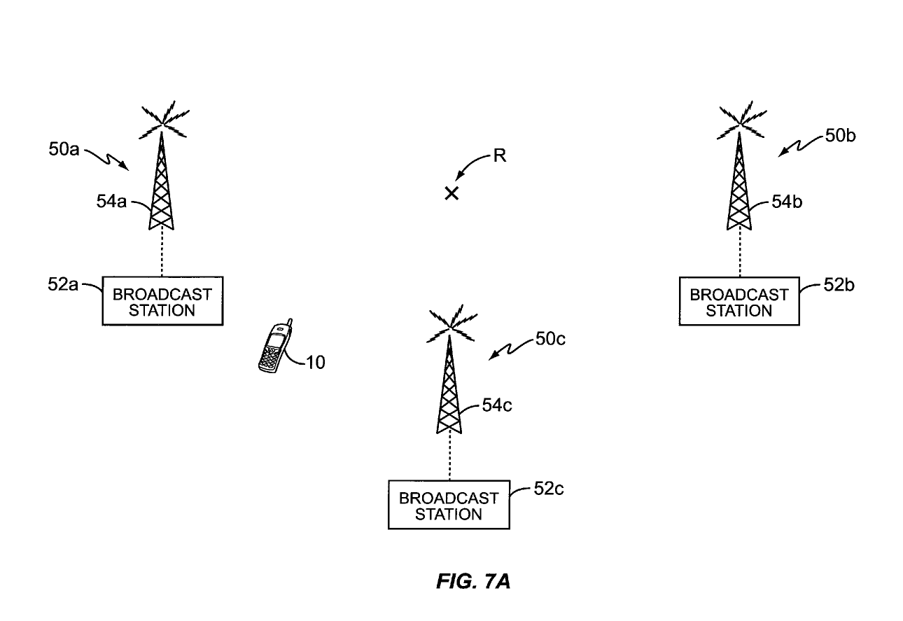

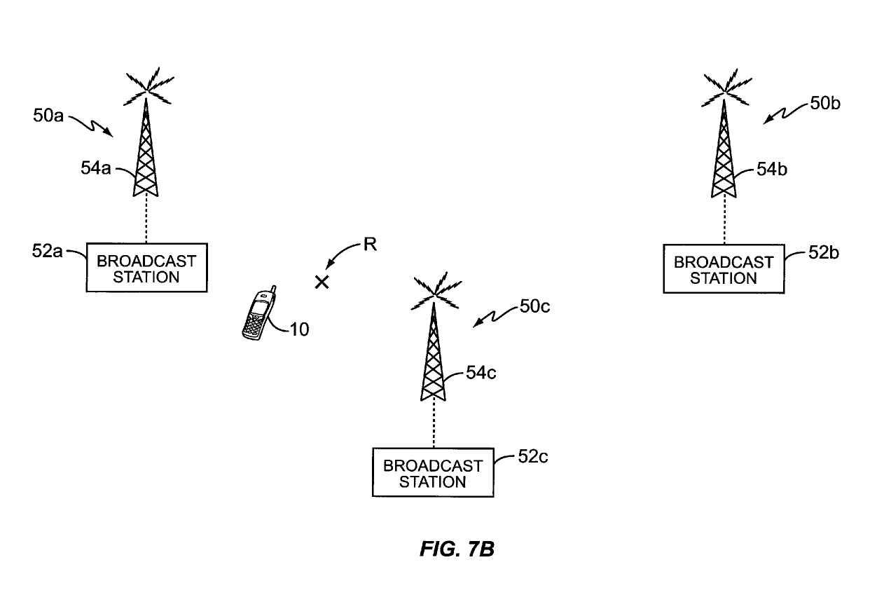

There are a plurality of ways in which the reference location may be calculated based on multiple antenna locations. As seen in FIG. 7A, for example, the controller 30 may obtain the geographical coordinates for a plurality of broadcast radio antennas 54a-54c, and then use known techniques to determine a substantially centrally located reference location R. For example, one possible technique is for device 10 to calculate the median point of the tower locations. FIG. 7B illustrates another embodiment wherein the controller 30 determines the reference location R to be a location in which the distance between the device 10 and the antenna 54a-54c locations is proportional to the measured signal strength values to within a predetermined threshold. More particularly, assuming a signal attenuation of r², the more distant radio stations 52 would have weaker received signal strength values, while closer radio stations 52 would have stronger received signal strength values. Controller 30 could determine the reference location R to be a geographical location in which the received signal strength values substantially indicate the device's distance from each of the actual antenna 54a-54c locations. This embodiment could provide an even more accurate reference location by accessing information regarding radiated power levels for each of the antennas 54a-54c. The regulatory bodies that maintain the database of antenna locations may also maintain the radiated power level information. This information may be retrieved when the locations of the antennas 54 are requested.

As previously stated, ephemeris data is also used by device 10 as GPS assistance data. Device 10 may use, for example, previously received assistance data, or precise ephemeris data from a previous position fix, that is stored in memory 28 and not yet stale. Generally, assistance data becomes stale after about four hours depending upon the locations of the satellites. In the absence of current precise ephemeris data, stored extended ephemeris data may be used, or controller 30 may be configured to obtain current ephemeris data.

Controller 30 may obtain current ephemeris data by any known method, however, in one embodiment, the ephemeris data may be provided with in the RDS message 80. Controller 30 could simply decode the RDS message 80 to obtain the ephemeris data and store it in memory. Alternatively, the ephemeris data may be provided to device 10 from one or more servers via the Internet, or from an entity within the wireless communications network 60.

Additionally, the embodiments herein describe the database that matches the identity of a broadcast radio station 52 to a set of physical, geographical coordinates on the Earth's surfaces as being a network database. Although such a structure is possible, one embodiment of the present invention downloads or saves at least a portion of the database contents to local memory. In such cases, device 10 could search for a reference location using the local memory first, and then generate the request message for the network server(s) 66 if the local search fails.

For example, in one embodiment, when device 10 acquires the location of an antenna 54, the controller 30 may store the identity of the broadcast radio station 52 and the coordinates of the antenna 54 location in a local database in memory 28. Over time, this allows the device 10 to build a partial database of geographical coordinates defining antenna 54 locations. Whenever device 10 receives an RDS signal, the controller 30 can save time and resources by first searching the local database in memory 28 to determine whether a corresponding antenna location is stored in memory 28. If a corresponding location is found in the local memory 28, the controller 30 can use the coordinates as the reference location. If a corresponding location is not found in the local database, however, the controller 30 could still obtain the information as previously described, and then update the local database as needed with the information.

In another embodiment, controller 30 stores the identities of broadcast radio stations 52 and/or the antenna 54 locations along with the measurements of received signal strengths. Then, whenever device 10 receives multiple RDS signals, controller 30 can attempt to match the measured received signal strengths with those stored in the local database in memory 28. Upon a match, the device 10 can use one or more of the stored antenna locations to calculate a reference location as previously described. Additionally, other data and information such as the ephemeris data may be cached in local memory 28 and used along with the determined reference location to acquire one or more of the navigational satellites.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. An electronic device comprising:
a receiver to receive a broadcast radio signal transmitted by a broadcast radio station, the broadcast radio signal including identifying information associated with the broadcast radio station;
a controller to determine a reference location based on the identifying information received from the broadcast radio station; and
a positioning circuit to acquire one or more satellites of a navigational system based on the determined reference location.

2. The electronic device of claim 1 wherein the broadcast radio signal comprises a first signal that carries multimedia content and a second signal that carries the identifying information associated with the broadcast radio station, the identifying information comprising geographical coordinates that identify a location of either the broadcast radio station or a fixed-site antenna.

3. The electronic device of claim 1 wherein the broadcast radio signal comprises a first signal that carries multimedia content and a second signal that carries the identifying information associated with the broadcast radio station, the identifying information comprising a station identifier that identifies the broadcast radio station.

4. The electronic device of claim 1 wherein the controller is configured to periodically synchronize a local clock with a time value, and wherein the positioning circuit is further configured to use the local clock as a reference time to acquire the one or more satellites.

5. The electronic device of claim 1 wherein the controller is configured to determine a location of a fixed-site antenna associated with the broadcast radio station, and determine the reference location based on the antenna location.

6. The electronic device of claim 5 further comprising a memory to store one or more previously acquired broadcast radio station identities and the locations of their corresponding fixed-site antennas, and wherein the controller is configured to:
search the memory for the identity of the broadcast radio station; and
if the identity is found, determine the reference location based on the location of a corresponding fixed-site antenna.

7. The electronic device of claim 1 wherein the controller is configured to measure a received signal strength for each of a plurality of broadcast radio stations transmitting respective broadcast radio signals over corresponding fixed-site antennas.

8. The electronic device of claim 7 further comprising a memory to store the received signal strengths for one or more previously acquired fixed-site antennas and their corresponding locations, and wherein the controller is configured to:
search the previously acquired received signal strengths for one or more of the measured received signal strengths; and
determine the reference location relative to the stored locations of one or more of the corresponding fixed-site antennas.

9. The electronic device of claim 7 wherein the controller is further configured to extract an identifier from a selected broadcast radio signal to identify the broadcast radio station.

10. The electronic device of claim 7 wherein the controller is configured to:
extract an identifier from each of two or more broadcast radio signals to identify respective broadcast radio stations;
determine the location of the corresponding fixed-site antenna for each identified broadcast radio station based on their respective identifiers; and
determine the reference location relative to each of the antenna locations.

11. The electronic device of claim 7 wherein the controller is further configured to determine the reference location to be a geographical position substantially central to each of the antenna locations.

12. The electronic device of claim 7 wherein the controller is further configured to determine the relative location to be a geographical position where the received signal strength value for each antenna matches a corresponding expected signal strength value for each antenna within a predetermined range.

13. The electronic device of claim 1 wherein the broadcast radio signal includes an indicator that identifies the broadcast radio signal as one having location assistance data, and wherein the controller is configured to scan a plurality of received broadcast radio signals for the indicator to determine which broadcast radio signals carry location assistance data.

14. A method of obtaining navigational assistance data at an electronic device, the method comprising:
receiving a broadcast radio signal at the electronic device, the broadcast radio signal comprising identifying information associated with a broadcast radio station transmitting the broadcast radio signal;
determining a reference location based on the identifying information included with the broadcast radio signal; and
acquiring one or more satellites of a navigational positioning system based on the reference location.

15. The method of claim 14 wherein the identifying information included with the broadcast radio signal comprises geographical coordinates that identifies a location of either the broadcast radio station, or a fixed-site antenna.

16. The method of claim 14 wherein receiving a broadcast radio signal at the electronic device comprises receiving a first signal carrying multimedia content and a second signal carrying the identifying information included with the broadcast radio signal, the identifying information comprising a station identifier that identifies the broadcast radio station.

17. The method of claim 14 further comprising:
synchronizing a local clock at the electronic device to a time value; and
acquiring the one or more satellites based on the reference location and the local clock.

18. The method of claim 14 further comprising:
storing one or more previously acquired broadcast radio station identities and the locations of their corresponding fixed-site antennas in a local memory;
searching the local memory for the identity of the broadcast radio station; and
determining the reference location based on the location of a corresponding fixed-site antenna.

19. The method of claim 14 wherein determining a reference location based on the identity of the broadcast radio station comprises:
determining a geographical location of a fixed-site antenna transmitting the broadcast radio signal; and
determining the reference location based on the geographical location of the fixed-site antenna.

20. The method of claim 14 further comprising:
receiving a plurality of broadcast radio signals respectively transmitted by a plurality of broadcast radio stations; and
measuring a received signal strength for each of the received broadcast radio signals.

21. The method of claim 20 further comprising:
storing the received signal strengths for one or more previously acquired fixed-site antennas and their corresponding locations;
searching the received signal strengths of the previously acquired fixed-site antennas for one or more of the measured received signal strengths; and
determine the reference location relative to the stored locations of one or more of the fixed-site antennas.

22. The method of claim 20 further comprising:
extracting an identifier identifying the broadcast radio station from the broadcast radio signal having the strongest received signal strength; and
determining the reference location to be a geographical position of a fixed-site antenna associated with the identified broadcast radio station.

23. The method of claim 20 further comprising:
extracting an identifier from two or more of the received broadcast radio signals to identify respective broadcast radio stations;
determining the location of a corresponding fixed-site antenna for each identified broadcast radio station based on the respective identifiers; and
determining the reference location relative to each of the antenna locations.

24. The method of claim 23 wherein determining the reference location relative to each of the antenna locations comprises determining the reference location to be a geographical position substantially central to each of the antenna locations.

25. The method of claim 23 wherein determining the reference location relative to each of the antenna locations comprises determining the relative location to be a geographical position where the received signal strength value for each antenna matches an expected signal strength value for that antenna within a predetermined range.

26. The method of claim 14 further comprising scanning the received broadcast radio signal for an indicator to determine whether the broadcast radio signal carries location assistance data.
